(19) United States
(12) Patent Application Publication
(10) Pub. No.: US 2026/0244185 A1
(43) Pub. Date: Aug. 20, 2026

(54) METHOD FOR CREATING A SAFETY CONFIGURATION

(71) Applicant: SICK AG, Waldkirch (DE)

(72) Inventors: Steffen WITTMEIER, Waldkirch (DE); Peter POKRANDT, Au am Rhein (DE); Jonas GRIMM, Freiburg (DE); Ulrich HEHL, Freiburg (DE); Tobias SCHUBERT, Endingen (DE)

(21) Appl. No.: 19/539,887

(22) Filed: Feb. 13, 2026

(30) Foreign Application Priority Data
Feb. 14, 2025 (EP) 25158151.8

(51) Int. Cl. G05B 19/4069; G05B 19/4061

(52) U.S. Cl. CPC G05B 19/4069; G05B 19/4061

(57) ABSTRACT

The invention relates to a method for creating a safety configuration for an industrial machine to avoid human injuries caused by the machine, wherein the method comprises that
the machine, which has at least one safety sensor, is provided, wherein the machine has a hazardous zone,
a simulation is performed that simulates an operation of the machine for carrying out a production task,
wherein the simulation comprises two agents, wherein a first of the agents attempts to enter the hazardous zone of the machine and a second of the agents attempts to prevent an entry into the hazardous zone by creating an adapted safety configuration from a previous safety configuration,
wherein the simulation is performed iteratively, wherein a reinforcement learning is performed for the first agent and/or the second agent to obtain a changed behavior of the first agent and/or the second agent in further iterations.

The present invention relates to a method for creating a safety configuration for an industrial machine to avoid human injuries caused by the machine.

Industrial machines are used in a variety of forms and shapes in industrial processes, for example, to manufacture products, to transport objects, to sort, to grip and the like. Such industrial machines can in particular be robots, processing machines or vehicles (e.g. so-called AGVs—Automated Guided Vehicles).

In particular due to the movement of the industrial machine itself or the movement of parts of the industrial machine, for example of robot arms, a risk to persons located in the vicinity can arise.

Conventionally, industrial machines are, for example, safeguarded by protected fields. In this respect, the effort for the initial definition of the protected fields is relatively high, which is in particular also applies to three-dimensional protected fields. Furthermore, there is the disadvantage that when a person intervenes in a protected field, the machine is usually slowed down or even stopped completely, which is detrimental to the productivity of the machine.

It is therefore the underlying object of the invention to specify a method that allows the safeguarding of an industrial machine, that reduces the effort for creating a safety configuration for the industrial machine and/or that increases the productivity of the industrial machine.

This object is satisfied by a method according to claim 1.

The (computer-implemented) method according to the invention for creating a safety configuration for an industrial machine in particular serves to avoid human injuries caused by the machine. In this respect, the method comprises that
preferably the machine, which has at least one safety sensor, in particular for detecting the environment of the machine, is provided, wherein the machine has a hazardous zone, preferably a changeable hazardous zone, and
a simulation is performed that simulates an operation of the machine for carrying out a production task.

In this respect, the simulation preferably comprises two agents, wherein a first of the agents attempts to enter into the hazardous zone of the machine and a second of the agents attempts to prevent an entry (of the first agent) into the hazardous zone by creating an adapted safety configuration from a previous safety configuration. Preferably, the simulation is performed iteratively, wherein a reinforcement learning is performed for the first agent and/or the second agent to obtain a changed behavior of the first agent and/or the second agent in further iterations. Preferably, a respective separate reinforcement learning is performed for each of the agents. Further preferably, due to the changed behavior of the second agent, the changed or adapted safety configuration is obtained in the iterations.

The invention is based on the realization that, by using the reinforcement learning and the two agents configured as counterparts in the simulation, a plurality of possible safety configurations can be set up by the second agent and tested by the first agent for possible vulnerabilities. In this way, it is possible to discard or further improve non-functioning safety configurations or inadequate safety configurations. In the course of the iterations of the simulation, still further adapted safety configurations can be generated until a safety configuration is present that is suitable for the operation of the industrial machine. The suitability can, for example, be determined in that a human injury cannot occur or can only occur with a predetermined probability, wherein preferably a predetermined productivity with respect to the productivity task of the industrial machine is additionally also fulfilled.

For the adapted safety configuration, the previous safety configuration can in this respect be partly adopted, wherein a part of the previous safety configuration is changed to generate the adapted safety configuration. It is likewise possible to completely discard the previous safety configuration and to completely recreate the adapted safety configuration. Such a complete recreation may e.g. be necessary if the first agent enters the hazardous zone, in particular in a plurality of iterations in succession.

The safety configuration can in this respect be understood as measures that can be taken to avoid or exclude human injuries at the machine. This can in particular include the slowing down of movements of the machine, the carrying out of evasive movements by means of the machine or the switching off of moving parts of the machine. Likewise, this can also include the creation of protected fields in the environment of the machine or other measures suitable for avoiding human injuries.

More precisely, due to the iterative reinforcement learning, it is also possible to evaluate a plurality of conceivable safeguarding types, i.e. safety configurations, so that a human effort for creating the safety configuration is minimized. Furthermore, completely new kinds or new combinations of measures within the safety configuration can be suggested by the reinforcement learning. In this respect, the safety configuration can in each case be changed iteratively in order thus to generate a new safety configuration, which is also designated as an adapted safety configuration herein, from a previous safety configuration. If a plurality of adapted safety configurations have been evaluated, the most suitable safety configuration or the last safety configuration available after a predefined number of iteration steps can, for example, be output as the final safety configuration. The final safety configuration can be applied in the real industrial machine, wherein the real industrial machine preferably adapts its behavior based on the final safety configuration. The real industrial machine can then behave in the same way as the industrial machine in the simulation. In this way, the safety configuration created in the simulation can have an effect on the real industrial machine.

In this connection, it must be clarified that in particular the simulation is meant in each case in the following when, for example, a movement of the agents or a detection by the safety sensor is spoken of. However, it is also understood that the movement of an agent can, for example, correspond to the movement of a real person close to the real industrial machine and that the detection by the safety sensor can likewise correspond to a real detection by the corresponding real safety sensor of the real industrial machine.

As initially mentioned, the industrial machine can in particular be robots, processing machines or vehicles (e.g. so-called AGVs—Automated Guided Vehicles) or combinations thereof.

Even further details of the invention will be explained below.

The safety sensor can be a sensor for monitoring the environment of the machine. The safety sensor can in particular be configured to recognize a person in the environment of the machine. Accordingly, the safety sensor can, for example, be a laser scanner, a LiDAR, an ultrasonic sensor, a camera and the like.

The hazardous zone is in particular to be understood as the region in which a human would certainly sustain an injury or in which an injury will occur at least with a very high probability, for example of more than 90% or 95%, if the person is present there and/or if at least one body part is located there. The hazardous zone can, for example, be the region of the position of a rotating milling head, the pivot range of a robot arm or the region in the direction of travel in front of an industrial machine configured as a mobile vehicle. A worst-case assumption can in particular also be made for the hazardous zone; the latter can therefore also be understood as a region in which an injury is at least possible.

In the simulation, the operation of the industrial machine is preferably simulated, wherein the operation serves to carry out a production task. The production task can e.g. be the processing of objects, provided that the industrial machine, for example, comprises a processing machine (such as a milling machine or a drilling machine). The production task can likewise be a transporting of objects (in particular with vehicles driving in an automated manner and/or autonomously driving vehicles). The function of the safety sensor can also be simulated in the simulation. Furthermore, in addition to the machine itself, one or more persons in the environment of the machine can also be simulated.

In particular, the first of the agents in the simulation can control at least one of the persons and can attempt to enter the hazardous zone of the machine with the simulated person. For the sake of simplicity, the simulated person is equated with the first agent herein; i.e. it is in particular stated that the first agent attempts to enter the hazardous zone of the machine.

Due to the second agent, the safety configuration is preferably changed in the simulation and an adapted safety configuration is thus created from the respective previous safety configuration (for a respective iteration step). The safety configuration can in particular also comprise the dynamic adaptation, for example the dynamic adaptation based on the movement of the first agent and/or the machine, of protected fields. The safety configuration can also have a machine action, in particular a machine movement.

In this respect, the adaptation of the safety configuration in particular takes place in response to a successful entry of the first agent into the hazardous zone of the machine or e.g. in response to a productivity of the industrial machine being too low, as will be explained in more detail later.

In short, the first agent therefore simulates the movement of a person who is supposed to enter the hazardous zone. The first agent therefore simulates an attacker, whereas the second agent attempts to prevent an entry of the first agent into the hazardous zone by means of a corresponding safety configuration. Due to a corresponding reward of the agents, for example of the first agent for a successful entry into the hazardous zone or of the second agent for maintaining the operation of the industrial machine, a corresponding optimization of the safety configuration can be achieved in that an injury of a human at the machine is avoided, but the productivity of the machine is simultaneously maintained. The details of the reward will also be explained later.

Further developments of the invention can be found in the description, in the drawings and in the dependent claims.

According to a first embodiment, the safety configuration comprises at least one set of rules for the movement of the machine, wherein the rules lead to predetermined movements, i.e., for example, behaviors, of the machine in dependence on the movement of the first agent (which can also be viewed as an “attacker”), wherein rules are preferably changed, added and/or deleted for the creation of the adapted safety configuration. The rules for the movement of the machine can, for example, comprise that the machine moves without restrictions if the first agent (and correspondingly a person in reality) has at least a predetermined distance from the machine. Furthermore, the rules can, for example, comprise that, when a machine is configured as a mobile vehicle, a movement towards the first agent is prevented if the first agent is closer to the machine than a predetermined threshold value. Likewise, it can be possible, for example, to brake a robot arm of the machine if the first agent comes too close to the robot arm. In general, in response to the position and/or movement of the first agent, for example, a slowing down, a stopping and/or a bypassing (i.e. a selection of a different movement path which can in particular comprise a detour) can take place.

Furthermore, the rules can comprise a sequence of movements that can e.g. fend off the first agent. The rules can also comprise rules for the movement, in particular the simultaneous or synchronized movement, of a plurality of different parts of the machine.

For the adaptation of the safety configuration, the rules can preferably be changed or new rules can be added or existing rules can be deleted in such a manner to prevent an entry of the first agent into the hazardous zone or e.g. to increase the productivity of the machine compared to the previously existing rules.

Changing the rules can reflect the “learning” through reinforcement learning and/or can generally be a trying out of different possibilities.

The machine (in the simulation and also in reality) generally comprises at least one part that is moved. A movement should in this respect be understood as, for example, a movement of a robot arm, a traveling of the machine as a whole or also the driving or rotation of a tool.

According to a further embodiment, the hazardous zone of the machine is adapted in the simulation in dependence on the movements of the machine, wherein the hazardous zone is preferably omitted when the machine is at a standstill. Due to the movement of the machine, the hazardous zone can be displaced to a different location; in the case of a movement at a higher speed, the hazardous zone can be enlarged and, in the case of a movement at a reduced speed, the hazardous zone can be reduced. If the machine comes to a complete standstill, a risk usually no longer arises from the machine so that the hazardous zone can be omitted in this case. It is then indeed no longer possible for the first agent to enter the hazardous zone, but the productivity of the machine then likewise drops to zero so that a permanent remaining in this state is undesired and—as explained later—can be prevented by a corresponding selection of the reward for the agents.

According to a further embodiment, the safety configuration comprises at least one protected field in the environment of the machine, wherein a protected field infringement by the first agent leads to a predetermined behavior, for example a movement, a safety-directed action and/or a change of the protected field and the like, of the machine, wherein, for the creation of the adapted safety configuration, an existing protected field is preferably changed and/or deleted and/or a protected field is added.

In other words, the safety configuration can therefore comprise one or more protected fields to ensure that the first agent cannot enter the hazardous zone. The protected fields of a respective safety configuration can in this respect be fixedly predefined or they can in turn be dynamic within the safety configuration itself and can, for example, be adapted to a position and/or a speed of the first agent and/or the machine. It is likewise possible to switch between different sets of protected fields within a safety configuration. The different sets of protected fields can be learned or predefined in advance in this respect. The switching between different sets of protected fields is designated as a special case of dynamic protected fields. In this respect, the protected fields of a set are then not changeable in themselves, but it is possible to switch between protected fields of different sets.

The protected field or the protected fields can, for example, be monitored by the safety sensor (in the simulation and also in reality). A safety-directed measure can furthermore be defined for each protected field and is performed in the event of a protected field infringement. For example, it is possible that the machine slows down a movement, stops it or diverts it to another movement path if a protected field infringement is recognized. In this way, the hazardous zone can be reduced and/or moved away from the first agent and/or can be completely omitted at least temporarily.

Furthermore, it is possible that the safety configuration comprises a logical and/or temporal linking of events in protected fields with movements or actions (e.g. safety-directed measures) of the machine. For example, a specific safety-directed measure can only be executed if two protected fields are infringed simultaneously (logical AND link) and/or if the same protected field is infringed multiple times within a predefined time period (temporal link).

However, if the first agent reaches the hazardous zone despite the protected fields, it is obvious that the previous protected fields of the current safety configuration are not sufficient and a change of the protected fields can be made in the next safety configuration, i.e. when creating the adapted safety configuration. With the protected fields of the adapted safety configuration, it is then again checked whether the first agent can enter the hazardous zone. A change of the protected fields in the adapted safety configuration can likewise be made if, for example, the protected fields are too large and thus restrict the productivity of the machine too much and/or too early.

In the simulation, a protected field infringement is preferably determined using simulated data of the safety sensor. Further safety sensors can also be added (in the simulation and in reality) to be able to span further protected fields, even at spatially different locations.

According to a further embodiment, the first agent is simulated in a point-like manner or as a body model, wherein the body model preferably enables a separate movement of body parts. A point-like simulation of the first agent has the advantage that the simulation can be carried out with little effort. In this respect, the position of the point-like agent can e.g. represent the position of a person (i.e. in particular their point of view) or the position of a limb of the person, e.g. a hand, the head or a leg.

By using a body model, the simulation can take place more accurately and with more detail. Thus, the body model can comprise a plurality of body parts, for example, a head, at least one arm, a hand and/or legs. The body model can enable the simulation of separate movements of these body parts. In this way, it can, for example, be simulated that the first agent stretches out his hand towards the hazardous zone. The second agent (who can also be viewed as a defender) can react differently to this than if the first agent is only located in the vicinity of the machine but does not stretch out his hand. Thus, in the case of the stretching out in the safety configuration, rules can again be stored that only trigger a certain movement or action of the machine when the hand is too close to the hazardous zone. The safety configuration can thus be even more finely tuned to the actions of the first agent.

In order not to make the simulation too complex, each body part of the body model can be represented by a maximum number of points in the simulation. The maximum number of points can, for example, be 30, 20, ten, eight, six, four or two. For example, it is possible to simulate an arm with two points, whereas a hand can, for example, be simulated with two points (for a rudimentary hand model) or with six points (one point for the carpus and one point for each finger; for a more detailed hand model).

According to a further embodiment, the safety configuration comprises different protected fields and/or different rules for the movement of the machine that are activated in dependence on a body posture of the first agent. The body posture is in particular to be understood as the position and/or orientation of the body parts of the body model of the first agent. For the second agent, important signals as to which movement of the first agent can be expected next can result from the body posture. Depending on whether the first agent, for example, lies on the ground, faces the machine or has the arms stretched to the front, the second agent can react differently, for example, by adjusting the movements of the machine or the protected fields in a safety configuration.

According to a further embodiment, the first agent comprises a plurality of entities that act separately from one another and that preferably collaboratively make the attempt that at least one entity enters the hazardous zone of the machine. The entities can in particular all be identical and can, for example, be simulated as a point model or as a body model, as described above. Different entities can also be mixed. Each entity can preferably simulate a separate person. Acting separately from one another can in particular mean that the entities (like real persons) can move independently of one another, but still work together, i.e. attempt in a coordinated manner to enter the hazardous zone.

For example, the plurality of entities acting separately from one another can collaborate in such a way to prevent entry protection, for example, by one entity closing a safety door while another entity is still in the space of the machine that is protected by the safety door. By closing the safety door, the machine can then start up again, whereby the space of the machine that is protected by the safety door then becomes the hazardous zone and the other entity has thus entered the hazardous zone. In reality, such a scenario could lead to serious injuries of the person in the hazardous zone. By simulating such a strategy, countermeasures can, however, also be found against a plurality of collaborating entities.

Preferably, the simulation enables the first agent to interact with parts of the machine and/or to move or change parts of the machine. The interaction, movement and/or change made possible in the simulation can at least partly correspond to what is also possible in reality. For example, the simulation can comprise—as mentioned above—a safety door of the machine being opened, which then also in the simulation leads to the usually intended behavior that those parts of the machine which are protected by the safety door stop their operation as long as the safety door is open. The simulation can likewise comprise that workpieces or environmental objects can be moved by the first agent or can be used in another way, for example, to bypass the safety configuration and to enter the hazardous zone.

According to a further embodiment, the first agent knows the safety configuration. The agent can therefore know the respective currently valid safety configuration, i.e. the first agent is familiar with e.g. the protected fields and/or the rules for moving the machine. In this way, a sensible safety configuration can be achieved in fewer iteration steps since the first agent does not in each case still have to learn where protected fields and the like are located.

However, it is also possible that the first agent does not know the safety configuration, at least for some of the iterations, and then has to learn via success and failure how the machine reacts or where protected fields may be located. It can in particular be the case that the first agent does not know the safety configuration if a predetermined number of iterations have already been run through with a known safety configuration to test a safety configuration with even further actions of the first agent. The behavior of the first agent without knowledge of the safety configuration can in this respect rather correspond to the behavior of a human in reality, who likewise does not know the exact safety configuration.

According to a further embodiment, the second agent only has data of the safety sensor available. This means that the second agent can only have the position and/or body posture of the first agent available in the detection zone of the safety sensor. This again corresponds to the real conditions in which the second agent can also only detect a person if the person is located in the detection zone of the safety sensor.

In this connection, it must be mentioned that the safety sensor can also comprise a plurality of individual sensors, in particular different individual sensors, that can also be attached at different locations.

It is likewise possible that the second agent always knows the positions or body postures of the first agent (and all entities), at least for some of the iterations of the simulation.

Preferably, the iterations can in particular start with the second agent always knowing the positions and body postures of the first agent. After a predetermined number of iterations or after a predetermined number of iterations in which the first agent was unable to enter the hazardous zone, iterations can then take place in which the second agent only has the data of the safety sensor available.

The data of the safety sensor can in particular be understood as all the sensor data that are available to the machine. In particular, sensors that, for example, serve to detect workpieces in the machine can also be used as safety sensors and can accordingly form the data basis to fend off the first agent.

In general, the agents can therefore completely know their environment at least in some of the iterations. In further iterations, the reality in which this absolute knowledge is not available can then be better mapped so that the agents only have a partial insight in each case, which can lead to more realistic scenarios. In particular, the function of sensors can in this respect be reconstructed in the simulation or it is simulated.

According to a further embodiment, the reinforcement learning comprises a reward for the agents, wherein the reward for the first agent and the second agent is different and/or rewards different behavior of the agents. In particular, the first agent receives a reward for entering the hazardous zone and/or the second agent receives a reward for carrying out the production task. As will be explained in more detail later for the reinforcement learning, the agents in particular strive to receive the highest possible reward. The reward for the first agent and the reward for the second agent are in particular selected such that they reward mutually contradictory behavior. If the first agent manages to enter the hazardous zone, this would normally lead to the machine being stopped and thus to the production task being stopped. The second agent, on the other hand, attempts to carry out the production task and, to this end, must minimize disruptions by the first agent as far as possible. The first and the second agent are thereby counterparts.

It is also possible that the second agent receives a reward for preventing the first agent from entering the hazardous zone. Usually, such a reward is, however, combined with a reward for carrying out the production task in order to prevent the second agent from simply switching off the machine permanently or simply generating a protected field that covers the entire environment of the machine, which would then lead to a standstill in the production task in each case.

According to a further embodiment, the reward for the first agent is reduced when the first agent is inactive and/or when a protected field is triggered. In general, the reward for the first agent can also be reduced when triggering a safety measure of the machine. Reducing the reward due to inactivity, i.e. a punishment for inactivity, can prevent a behavior of the first agent in which the first agent simply waits. Then, no meaningful safety configuration could be generated in the reinforcement learning. Due to the punishment when triggering a protected field or when triggering a safety measure in general, the first agent can learn where protected fields are located and/or how the safety measures of the machine work. This is in particular relevant if the first agent does not know the safety configuration. Furthermore, it can thus be brought about that the first agent attempts to reach the hazardous zone in a more targeted manner and does not “fall for” the defense of the machine.

According to a further embodiment, the reward for the second agent depends on a duration of the carrying out of the production task and/or on an effectiveness of the carrying out of the production task. The effectiveness of the production task can, for example, indicate how many parts the machine processes, i.e., for example, produces, transports or distributes, per time unit. The reward can be higher with a higher productivity, i.e. in particular with a longer duration of the carrying out of the production task, with a certain effectiveness simultaneously prevailing during the duration of the carrying out. A higher productivity is therefore rewarded.

In particular, the second agent is rewarded for the machine having runtimes that are as long as possible. In addition to a standstill of the machine, a slowing down of the process and/or a switching to other, for example deviating, work paths can be part of the safety configuration. For example, the highest reward can be obtained for a maximum speed of the carrying out of the production task, not just for a mere runtime of the production task.

It is likewise possible that the reward of the first agent directly correlates negatively with the reward of the second agent and vice versa. In particular, a predefined reward (for example, a number of points) can, for example per iteration, be divided between the first agent and the second agent. If the second agent, for example, does not manage to maintain a sufficiently high throughput in the production task, the first agent then receives a higher reward and the second agent a lower reward.

Furthermore, it is possible to link the reward of the second agent, for example, to the size and/or the “footprints” of the spanned protected fields. A smaller size of the protected fields in this respect enables more flexibility and can therefore go hand in hand with a higher reward. The size of the protected fields can in this respect be the spanned area of the protected fields or the volume monitored by the protected fields.

According to a further embodiment, the machine unit comprises a collaboration zone. In the collaboration zone, a transfer of workpieces between the machine and the first agent (or a person in the real world) can in particular take place. A common processing of a workpiece can likewise take place. Preferably, the first agent and/or the second agent receives/receive a reward for a successful cooperation of the first agent and the machine in the collaboration zone. For example, a reward can in each case take place in that a workpiece was successfully handed over in the collaboration zone. Alternatively or additionally, a reward for the agents can take place if the respective other agent has been allowed access to the collaboration zone for at least a certain time period, wherein access is e.g. made possible in that the first agent or the machine is located at least a predefined distance away from the collaboration zone.

The reward for the first and/or second agent that can be achieved via the collaboration zone can in particular be lower than a reward of the first agent that is achieved by a successful entry into the hazardous zone and/or than a reward for the second agent that is achieved by a successful carrying out of the production task. In this way, in particular the first agent can continue to attempt to enter the hazardous zone and the second agent must continue to design the safety configuration such that, even in the case of a cooperation in the collaboration zone, there is no risk of the first agent entering the hazardous zone.

The collaboration zone can in particular be protected by structural measures of the machine against too simple an entry of the first agent into the hazardous zone. For example, the collaboration zone can comprise a pass-through configured as a window, wherein a movable part of the machine (for example a robot arm) is provided on one side of the pass-through and the first agent can only be located on the other side of the pass-through. In this way, it may only be necessary that the second agent in the safety configuration has to take measures to prevent the first agent from e.g. stretching a hand through the pass-through if the hazardous zone is in particular located close to the pass-through.

Different ones of the above rewards are preferably combined with one another. In particular, the different rewards are weighted differently. Due to a different weighting, a different result for the safety configuration or the final safety configuration can be achieved. For example, with a higher weighting of the duration of the runtime of the production task, it can be achieved that fewer interruptions take place, whereas, e.g. with a higher weighting of a successful cooperation in the collaboration zone, more frequent interruptions of the production task will possibly arise, but the cooperation in the collaboration zone is possible in an improved manner in return.

According to a further embodiment, the iterative performance of the simulation comprises that only one reinforcement learning of one of the agents is carried out for a number, in particular a predetermined number, of iterations in each case, wherein thereafter, in particular again for a predetermined number of iterations, only one reinforcement learning of the other of the agents is then carried out. In particular, a reinforcement learning of the agents can thus be carried out alternately, wherein a respective agent then has a plurality of iterations available in each case in order e.g. to manage the entry into the hazardous zone or to successfully fend off the first agent.

An alternating reinforcement learning for the agents can reduce the computational effort up to the achieving of the final safety configuration since the number of iterations and/or the complexity of the iterations can thereby be reduced. If, for example, a reinforcement learning is started for the first agent, the second agent then does not have to react to still incomplete attacks of the first agent, whereby computing time can be saved. In other words, the search space is limited if the first and second agent are not trained simultaneously, but are rather trained successively or offset. For example, the first agent can therefore initially be confronted with a fixedly predefined safety configuration. Only when the first agent is able to overcome the predefined safety configuration, the reinforcement learning of the second agent is performed in order again to prevent the entry of the first agent into the hazardous zone by creating an adapted safety configuration. Such a procedure can be repeated iteratively, in particular until the first agent is no longer able to enter the hazardous zone. The safety configuration that is then present can then be regarded as the final safety configuration and can be output to the real machine.

In general, the final safety configuration can also be present if the first agent does not succeed in entering the hazardous zone in a predetermined number of iterations and/or if the machine is able to perform the productivity task sufficiently well, which can e.g. be determined by a productivity threshold value.

A few more details on the reinforcement learning and the simulation are given below.

The reinforcement learning is a method for machine learning whose aim is to train an artificial intelligence or to learn a behavior, a set of rules and/or a policy by maximizing a reward. Here, the first agent and the second agent interact with their environment by trying out different actions. As described above, an agent can be rewarded for an action that is positive for him, whereas the agent is indirectly punished for an action that is negative for him by reducing or omitting the reward. From this experience, the first and the second agent learn which actions are advantageous and which are not. In this way, the first agent can therefore e.g. adapt his movements to successfully enter the hazardous zone, whereas the second agent can continue to improve the safety configuration to prevent an entry of the first agent into the hazardous zone, but the production task is simultaneously fulfilled. In this respect, the learning can in particular take place recursively, i.e. the learning of the first and second agent can build on the experience of previous iterations in each case.

In general, a state space is defined for reinforcement learning and comprises the possible situations in which an agent can find himself. In the present disclosure, the state space is formed by the simulation. A current state of the simulation can in particular include all the information that is required to derive actions of the first and/or second agent. The simulation can furthermore comprise an action space that specifies the possibilities which the first and/or the second agent can perform in a specific state. If the first agent is, for example, located next to a wall, the action space only comprises the possibilities of moving the first agent further away from the wall, but not the possibility of moving it through the wall. In the same way, the action space for the second agent, which has already expanded a protected field to the maximum size permitted by the safety sensor, can only allow an adaptation of the protected field such that the protected field is reduced again.

Due to the reinforcement learning, the agents usually learn a strategy that is also called a policy. In the present disclosure, the strategy of the second agent is mapped in the safety configuration. The strategy of the first agent can comprise the situation-dependent and/or state-dependent movements or movement patterns that allow the first agent to enter the hazardous zone.

The learning for reinforcement learning can, for example, take place by Deep Q-Networks (DQN), by Proximal Policy Optimization (PPO), by Soft Actor-Critic (SAC) models and/or by Actor-Critic models (such as A3C or A2C).

The simulation can take place in discrete steps or continuously. If the simulation takes place in discrete steps, the DQN can in particular be used that achieves good results for discrete actions, in particular if the state space is large. PPO can be selected for continuous simulations—as can SAC that has good exploration properties and thus improves the evaluation of new strategies. Actor-critic models can in particular be used when the first agent and the second agent perform the reinforcement learning simultaneously or in parallel with one another. For the reinforcement learning, a separate artificial neural network can in particular be present for each of the agents and is adapted by the learning of the agents, for example, by adjusting weights in the individual neurons of the networks.

For example, the neural network can comprise an input layer into which the data available for the first or second agent in each case are entered. This can be followed by a plurality of hidden layers that produce an output that is returned to the simulation by an output layer. The output can, for example, comprise actions of the first agent or a change to the safety configuration.

In the case of an actor-critic model, the hidden layers can be divided into an actor network and a critic network in each case.

In general, the artificial neural networks can be configured as fully connected or as convolutional neural networks.

Specifically, there can for example, be just as many neurons in the input layer as there are input values. For example, 100 neurons can be present, provided that 100 input values are available in the simulation, e.g. for the second agent, and comprise, for example, speeds, distances and the like measured by the safety sensor in different regions. The output layer can, for example, likewise comprise 100 neurons that reset corresponding values in the safety configuration. However, for the first agent, the output layer can also, for example, comprise only four neurons, in particular if the first agent is simulated in a point-like shape, wherein only four possible actions can be output, for example, a movement forwards, backwards, to the left or to the right.

It is explained purely by way of example for DQN that the Deep Q-Network calculates a Q-value function that estimates how worthwhile it is for the respective agent to perform an action in the current state of the simulation. The learning can in this respect take place such that the calculation attempts to minimize a loss function.

In particular, the simulation can include an environment of the industrial machine that enables the agents to perform realistic actions that correspond to possible actions in reality.

The simulation can in particular take place in environments such as Nvidia Omniverse or Unity, wherein such environments make it possible to simulate sensors, industrial environments, robots and/or persons. Alternatively or additionally, it is possible to carry out the simulation in OpenAI Gym, in particular with an extension for adversarial reinforcement learning. Further alternatives or add-ons for carrying out the simulation are Mujoco or Bullet Physics.

The method explained herein can in particular be performed on an electronic computing device. GPU-based or TPU-based hardware (Graphics Processing Unit or Tensor Processing Unit) can in particular be used for the reinforcement learning. The computing device can in particular use frameworks such as PyTorch, TensorFlow and/or Stable Baselines3.

Preferably, the data on which the simulation is based, and in particular the data of the industrial machine used in the simulation, can originate from measurements at a real industrial machine, from computer drawings (CAD drawings) of the real industrial machine, from control data and/or movement data from a real machine control of the real machine and the like.

The simulation can, for example, take place in two dimensions and can represent the machine and the first agent from a bird's eye view, for example. However, a three-dimensional simulation is likewise possible in order, for example, to be able to consider a standing up or ducking of the first agent in the simulation. In both cases, the simulation can take place in a time-discrete manner, for example in time steps of 0.1 seconds, 0.5 seconds or one second. A continuous simulation is likewise possible. It is possible to end an iteration when, for example, the first agent has managed to enter the hazardous zone or when the first agent has triggered a safety-directed function of the industrial machine.

An iteration in the simulation can alternatively or additionally last a predetermined time period, for example a period of one minute, five minutes or ten minutes is simulated in an iteration, wherein the iteration is terminated after the predetermined time period has been reached.

In each iteration, in particular at the end of each iteration, the respective state of the simulation can be assessed by an observation unit, also called an interpreter. The observation unit can then define the reward for the first agent and/or the second agent based on the state.

According to a further embodiment, static and/or dynamic environmental objects are present in the environment of the machine in the simulation and are preferably used by the first and/or second agent. For example, the first agent can use an environmental object to protect himself from being detected by the safety sensor of the machine. It is likewise possible that, for example, a machine configured as an AGV takes a detour around an obstacle, wherein the obstacle then prevents the first agent from getting in the way of the AGV.

A further subject of the invention is a system for creating a safety configuration for an industrial machine, said system preferably comprising the industrial machine and an electronic computing device, wherein the machine has at least one safety sensor, wherein the machine has a hazardous zone. The electronic computing device performs a simulation that simulates an operation of the machine for carrying out a production task, wherein the simulation comprises two agents, wherein a first of the agents attempts to enter the hazardous zone of the machine and a second of the agents attempts to prevent an entry into the hazardous zone by creating an adapted safety configuration from a previous safety configuration. The simulation is performed iteratively, wherein a reinforcement learning is performed for the first agent and/or the second agent to obtain a changed behavior of the first agent and/or the second agent in further iterations.

The electronic computing device can be integrated into the industrial machine or can be designed separately from the industrial machine. The computing device can transmit the final safety configuration to the industrial machine via an electronic data connection.

The statements on the method according to the invention apply accordingly to the system according to the invention. This in particular applies with respect to advantages and embodiments.

The invention will be described purely by way of example with reference to the drawings in the following. There are shown:

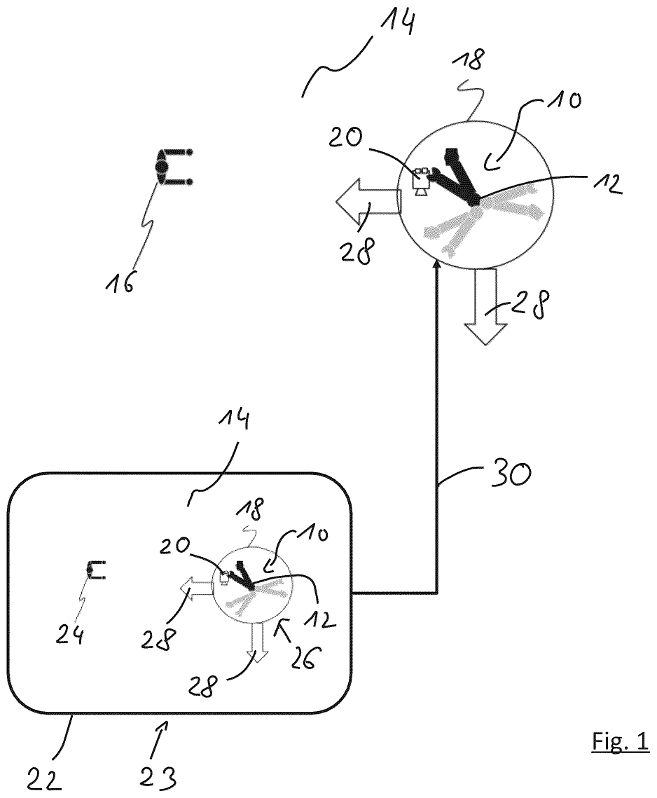

FIG. 1 an industrial machine with a person located in the vicinity and a simulation of the industrial machine;

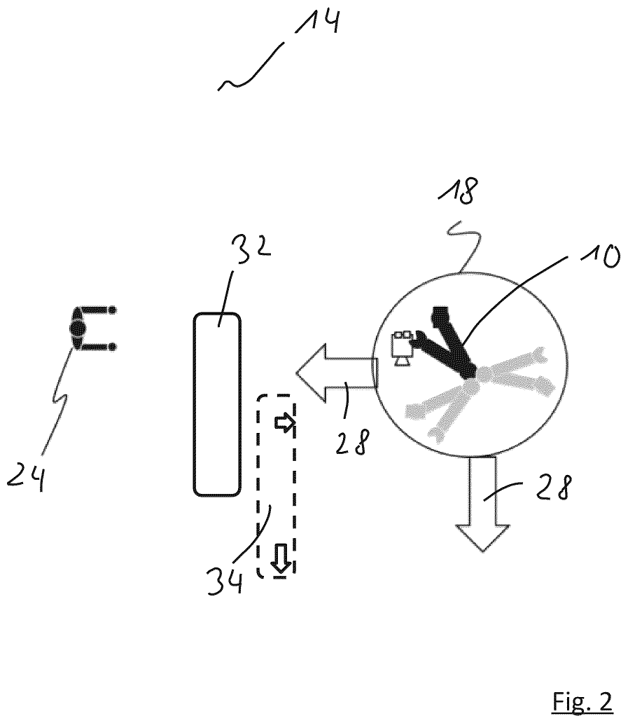

FIG. 2 the formation of protected fields in the environment of the industrial machine;

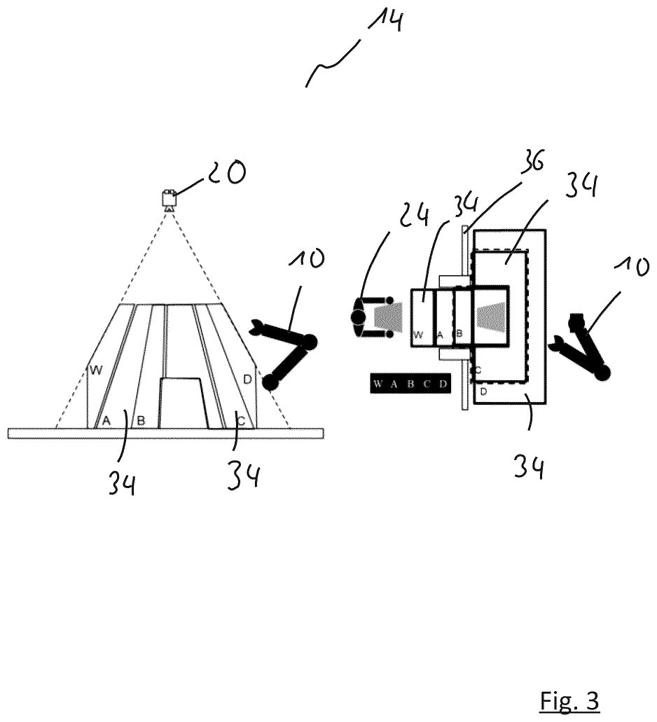

FIG. 3 a protected field switch;

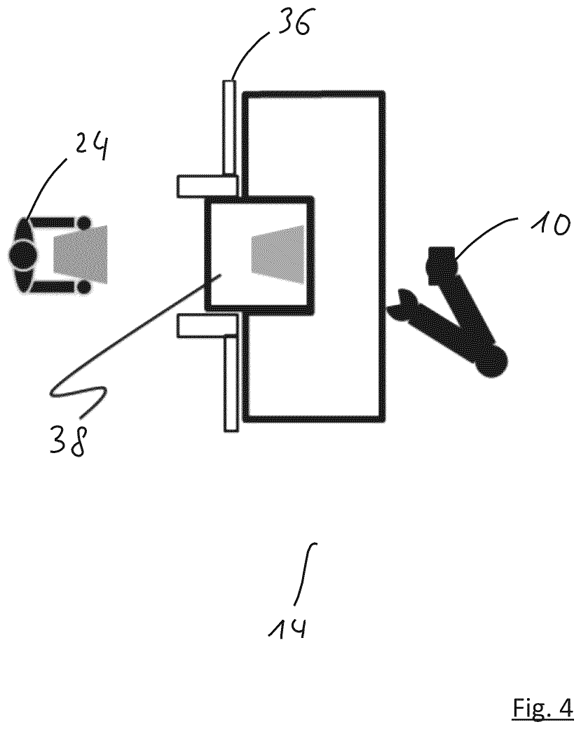

FIG. 4 an industrial machine with a collaboration zone; and

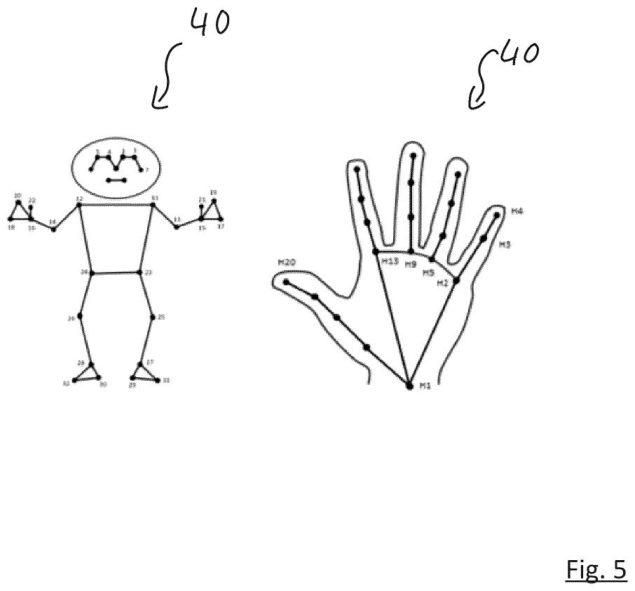

FIG. 5 a body model of the first agent.

FIG. 1 shows an industrial machine 10 that has a robot arm 12 that is movable in itself. The industrial machine 10 is furthermore configured to move as a whole in an environment 14. There is a person 16 in the environment 14 who could potentially injure himself at the machine 10.

Such an injury can in particular occur in a hazardous zone 18 that can be designed in different sizes and can be differently positioned depending on the speed and position of the machine 10 or the robot arm 12.

The machine 10 comprises a safety sensor 20 with which at least a part of the environment 14 can be detected. The safety sensor 20 can, for example, detect the person 16.

FIG. 1 furthermore shows an electronic computing device 22 for carrying out a simulation 23 of the industrial machine 10 and the person 16 in the environment 14. In the simulation, the person 16 is designated as the first agent. The industrial machine 10 can be controlled by a second agent 26, wherein a safety configuration is generated and/or adapted by the simulation 23 and in particular by the second agent to prevent the first agent 24 from entering the hazardous zone 18.

The simulation is performed iteratively, wherein a reinforcement learning is performed for the first agent 24 and the second agent 26 by means of the computing device 22. In the reinforcement learning, the first agent 24 is rewarded for entering the hazardous zone 18 of the machine 10. The second agent 26, on the other hand, is rewarded for preventing the first agent 24 from entering the hazardous zone 18. A further reward takes place if the second agent 26 makes it possible that the industrial machine 10 continues to fulfill a production task.

To create an increasingly adapted safety configuration, the second agent can in particular set up different rules for the movement of the machine 10. The rules can in this respect comprise specific movements of the robot arm 12 or movements of the entire machine 10. The movements are in particular shown by arrows 28 in FIG. 1. For example, the second agent 26 can prevent the first agent 24 from entering the hazardous zone 18 by moving the machine 10 away from the first agent 24. Furthermore, it is possible, for example, to move the robot arm 12 such that the hazardous zone 18 is located on the side of the machine 10 facing away from the first agent 24 in each case.

If, after a plurality of iterations, it is determined that a safety configuration has been found that (at least almost) excludes an entry of the first agent 24 into the hazardous zone 18 and simultaneously enables a fulfillment (at least in part) of the production task, this safety configuration can be transferred to the (real) industrial machine 10 as the final safety configuration 30 and can be used by the machine 10 in its (real) operation.

The safety configuration that is created by the second agent and is iteratively adapted again and again can, for example, also comprise protected fields, as is shown in FIG. 2. FIG. 2 shows a static protected field 32 and a dynamic protected field 34 within the simulation 23. The dynamic protected field 34 can, in particular based on the position of the first agent 24, be adapted in its position and size in each case. In the simulation 23, it is thus possible to test different protected fields 32, 34 and to evaluate their suitability for the later real use.

FIG. 3 shows a special case of dynamic protected fields 34. A simulation 23 of the industrial machine 10 is shown there, wherein the industrial machine 10 is at least partly shielded from the first agent 24 by environmental objects 36. FIG. 3 shows the simulation once in a plan view and once in a side view. In the design of FIG. 3, the dynamic protected fields 34 cannot be adapted as desired. Instead, sub-protected fields W, A, B, C and D are defined that cannot be changed but that can be individually activated or deactivated. In this way, the search space for the reinforcement learning can be reduced to arrive at a final safety configuration more quickly.

FIG. 4 shows an industrial machine 10 that is arranged adjacent to a collaboration zone 38. The collaboration zone 38 is again formed by environmental objects 36, here, for example, in the form of walls or a pass-through. The reward for the first agent 24 and the second agent 26 can comprise a component that rewards a successful cooperation between the first agent and the industrial machine 10 in the collaboration zone 38.

It must be mentioned that the environmental objects 36 can in particular also comprise dynamic objects (not shown), such as a lift truck or a garbage can, which the first agent 24 can use to his advantage.

In FIGS. 1 to 4, the first agent 24 is immobile per se in each case, i.e. is ultimately modeled as a point and is only schematically shown in human-like form in the Figures. In particular in the case of a close cooperation between the person 16 and the machine 10 or the first agent 24 and the machine 10, it may be useful to simulate the first agent 24 as a body model. FIG. 5 shows two such body models 40. The body model 40 shown at the left in FIG. 5 simulates the entire body of a human, wherein the hands and arms are, however, only modeled with a few points in each case. The body model 40 shown on the right side in FIG. 5 only relates to one hand, but in this respect simulates multiple joints in each finger and, in this way, is suitable for a very close cooperation in the collaboration zone 38. In particular, each point of the body models 40 is individually movable, wherein a connecting distance (shown by connecting lines between adjacent points) must be maintained, however.

Due to the simulation of the first agent 24, the second agent 26, the industrial machine 10, environmental objects 36 and, for example, the body models 40, a realistic reproduction of the real environment 14 in the simulation 23 can be achieved. Strategies and techniques for maintaining the production task learned through the reinforcement learning with a simultaneous safeguarding of the hazardous zone 18 can thus be transferred to the real industrial machine 10. Due to the reinforcement learning in the simulation 23, in particular an automatic creation of the final safety configuration 30 is possible in this respect, whereby the effort and the required time for creating the safety configuration can be reduced.

### REFERENCE NUMERAL LIST

10 industrial machine
12 robot arm
14 environment
16 person
18 hazardous zone
20 safety sensor
22 computing device
23 simulation
24 first agent
26 second agent
28 movement
30 final safety configuration
32 static protected field
34 dynamic protected field
36 environmental object
38 collaboration zone
40 body model

1. A method for creating a safety configuration for an industrial machine to avoid human injuries caused by the machine, wherein the method comprises that
the machine, which has at least one safety sensor, is provided, wherein the machine has a hazardous zone,
a simulation is performed that simulates an operation of the machine for carrying out a production task,
wherein the simulation comprises two agents, wherein a first of the agents attempts to enter the hazardous zone of the machine and a second of the agents attempts to prevent an entry into the hazardous zone by creating an adapted safety configuration from a previous safety configuration,
wherein the simulation is performed iteratively, wherein a reinforcement learning is performed for the first agent and/or the second agent to obtain a changed behavior of the first agent and/or the second agent.

2. The method according to claim 1,
wherein the safety configuration comprises at least one set of rules for the movement of the machine, wherein the rules lead to predetermined movements of the machine in dependence on the movements of the first agent.

3. The method according to claim 1,
wherein the hazardous zone of the machine is adapted in the simulation in dependence on the movements of the machine.

4. The method according to claim 1,
wherein the safety configuration comprises at least one protected field in the environment of the machine, wherein a protected field infringement by the first agent leads to a predetermined behavior of the machine.

5. The method according to claim 1,
wherein the first agent is simulated in a point-like manner or as a body model.

6. The method according to claim 1,
wherein the safety configuration comprises different protected fields and/or different rules for the movement of the machine that are activated in dependence on a body posture of the first agent.

7. The method according to claim 1,
wherein the first agent comprises a plurality of entities that act separately from one another.

8. The method according to claim 1,
wherein the first agent knows the safety configuration.

9. The method according to claim 1,
wherein the second agent only has data of the safety sensor available.

10. The method according to claim 1,
wherein the reinforcement learning comprises a reward for the agents, wherein the reward for the first agent and the second agent is different and/or rewards different behavior of the agents.

11. The method according to claim 10,
wherein the reward for the first agent is reduced when the first agent is inactive and/or when a protected field is triggered, and/or
wherein the reward for the second agent depends on a duration of the carrying out of the production task and/or on an effectiveness of the carrying out of the production task.

12. The method according to claim 1,
wherein the machine comprises a collaboration zone and the first agent and/or the second agent receives/receive a reward for a successful cooperation of the first agent and the machine in the collaboration zone.

13. The method according to claim 1,
wherein the iterative performance of the simulation comprises that only one reinforcement learning of one of the agents is carried out for a predetermined number of iterations in each case, wherein, after the predetermined number of iterations, thereafter only one reinforcement learning of the other of the agents is then carried out.

14. The method according to claim 1,
wherein static and/or dynamic environmental objects are present in the environment of the machine in the simulation.

15. A system for creating a safety configuration for an industrial machine, said system comprising the industrial machine and an electronic computing device, wherein the machine has at least one safety sensor, wherein the machine has a hazardous zone,
wherein the electronic computing device performs a simulation that simulates an operation of the machine for carrying out a production task, wherein the simulation comprises two agents, wherein a first of the agents attempts to enter the hazardous zone of the machine and a second of the agents attempts to prevent an entry into the hazardous zone by creating an adapted safety configuration from a previous safety configuration,
wherein the simulation is performed iteratively, wherein a reinforcement learning is performed for the first agent and/or the second agent to obtain a changed behavior of the first agent and/or the second agent in further iterations.

16. The method according to claim 1, wherein a reinforcement learning is performed for the first agent and/or the second agent to obtain a changed behavior of the first agent and/or the second agent, and thus a changed safety configuration in further iterations.

17. The method according to claim 2,
wherein rules are changed, added and/or deleted for the creation of the adapted safety configuration.

18. The method according to claim 4,
wherein, for the creation of the adapted safety configuration, an existing protected field is changed and/or deleted and/or a protected field is added.

19. The method according to claim 7,
wherein the plurality of entities collaboratively make the attempt that at least one entity enters the hazardous zone of the machine.

20. The method according to claim 10,
wherein the first agent receives a reward for entering the hazardous zone and/or the second agent receives a reward for carrying out the production task.

21. The method according to claim 14,
wherein the static and/or dynamic environmental objects are used by the first and/or second agent.
